(19) United States
(12) Patent Application Publication
(10) Pub. No.: US 2005/0136198 A1
(43) Pub. Date: Jun. 23, 2005

(54) Insulating glass units with inserts and method of producing same

(75) Inventors: Emmanuelle Bourlier, Santa Monica, CA (US); Christian B. Mitman, New York, NY (US)

Correspondence Address: FITZPATRICK CELLA HARPER & SCINTO, 30 ROCKEFELLER PLAZA, NEW YORK, NY, 10112, US

(73) Assignee: PANELITE, L.L.C., New York, NY (US)

(21) Appl. No.: 10/991,031

(22) Filed: Nov. 17, 2004

Related U.S. Application Data
(60) Provisional application No. 60/520,673, filed on Nov. 18, 2003.

(51) Int. Cl. E06B 3/24

(52) U.S. Cl. 428/34; 428/73

(57) ABSTRACT

An architectural insulating glass unit with an insert in the airspace is disclosed The IGU comprises two glass facings; an open cell honeycomb insert sized to be positioned between the two glass facings in the insulating glass unit; and a perimeter spacer dimensioned to secure the two glass facings and the open cell honeycomb in the insulating glass unit, wherein the open cell honeycomb insert is between the two glass facings. In one embodiment, the open cell honeycomb insert is constructed from polycarbonate tubular honeycomb. In another embodiment, the open cell honeycomb insert is regular. In the preferred embodiment, the open cell honeycomb insert is constructed from regular polycarbonate tubular honeycomb. A method for preparing the insert is also disclosed.

### CROSS-REFERENCE TO RELATED APPLICATION(S)

None.

### FIELD OF THE INVENTION

The present invention relates to architectural insulating glass units.

### BACKGROUND OF THE INVENTION

Architectural insulating glass units (IGU) are typically constructed of two glass facings and a perimeter edge seal. The perimeter edge seal holds the two glass facings in place, which are then sealed using a variety of sealants. If the IGUs are produced in accordance with the Insulating Glass Certification Council (IGCC) specifications, the seal will consist of a double silicone seal. In a conventional IGU the space between the glass facings in the center of the IGU is filled with air, and is therefore sometimes referred to as the airspace.

While commonly used in the architectural industry, conventional IGUs have some limitations associated with their use. Primary among them is their visual and heat conducting properties. As they are typically constructed of glass, conventional IGUs allow high amounts of sunlight and heat to penetrate into the interior of a building. This can have a significant effect on the amount of energy required to cool a building in warmer climates and typically tinted or reflective films or coatings are applied to mitigate the effects of solar heat.

Additionally, the visual characteristics of conventional IGUs are not desirable in all situations. Traditional IGUs typically provide complete visibility, in both directions, and therefore, offer no privacy from persons on the opposite side of the unit.

Traditional IGUs do not permit control over the visual characteristics of the IGUs. It would be desirable to have an IGU that allows better control of the visual. characteristics of the IGU. It would be desirable to have an IGU that allows better control over the degree of privacy and the amount of light penetrating the unit. It would also be desirable to have an IGU that better controlled the heat conduction into the interior of a building from sunlight.

### SUMMARY OF THE INVENTION

An architectural insulating glass unit with an insert in the airspace is disclosed. The IGU comprises two glass facings; an open cell honeycomb insert sized to be positioned between the two glass facings in the insulating glass unit; and a perimeter spacer dimensioned to secure the two glass facings and the open cell honeycomb in the insulating glass unit, wherein the open cell honeycomb insert is between the two glass facings. In one embodiment, the open cell honeycomb insert is constructed from polycarbonate tubular honeycomb. In another embodiment, the open cell honeycomb insert is regular. In the preferred embodiment, the open cell honeycomb insert is constructed from regular polycarbonate tubular honeycomb. In one embodiment, the open cell honeycomb insert may be cut in a range of about +0.00″ to −0.04″ less in thickness and −0.00″ to +0.03″ less in length and width than the specified airspace of the IGU into which it is inserted. The open cell honeycomb insert may be prepared using a dust removal process producing a visual grade insert.

A method for preparing an insert for insertion into the airspace of an industrial glass unit is also disclosed. The method comprises the following steps: slicing a block of open cell tubular honeycomb into sheets of a thickness compatible with the thickness of the airspace of the insulating glass unit; cutting the sheets of open cell tubular honeycomb to a length and width compatible with length and with of the airspace of the insulating glass unit to form an insert; and cleaning the insert using high pressure air.

In one embodiment the slicing of a block of open cell tubular honeycomb is performed with a high speed rotating saw blade. In another embodiment, the dust generated by the high speed rotating saw blade is removed as much as possible from the core insert by a downdraft vacuum system.

In the method, cutting the sheets of open cell tubular honeycomb to a length and width is preferably performed using a computer numerically controlled saw and the sheets are cut in a range of about +0.03″ to −0.00″ less in length and width than the specified airspace of the IGU into which it will be inserted.

A method for constructing an architectural glass unit is also disclosed. The method comprises the following steps: adhering a first lite of glass to a perimeter spacer, placing an open cell honeycomb insert within the perimeter of the spacer adjacent to the first lite of glass; and, adhering a second lite of glass to the perimeter spacer, wherein the open cell honeycomb insert is sized to fit securely within the perimeter spacer between the first and second lite of glass. Optionally, the method further comprises the step of sealing the unit. In one embodiment the sealing of the unit is done with a double silicon seal.

### BRIEF DESCRIPTION OF THE DRAWINGS

The accompanying drawings are incorporated in and constitute a part of this specification and, together with the description, explain the advantages and principles of the invention. In the drawings,

FIG. 1 is an exploded perspective view of the components of an IGU of the present invention.

FIG. 2 is an assembled perspective view of an embodiment of an IGU of the present invention.

FIG. 3 is a cut-away sectional view of a portion of an assembled IGU of the present invention.

FIG. 4 is a diagram showing the relationship between the distance of the observer to the IGU and the observer's cone of vision through the unit.

FIG. 5 is a diagram showing the relationship between the angle of the observer to the IGU and the observer's cone of vision through the unit.

FIG. 6 is a diagram showing the relationship between the thickness of the IGU insert and the observer's cone of vision through the unit.

FIG. 7 is a diagram showing the relationship between the cell sizes of the IGU insert and the observer's cone of vision through the unit.

### DETAILED DESCRIPTION

An architectural insulating glass unit (IGU) with an open cell honeycomb insert is disclosed. A method for constructing the IGU with the insert, as well as a method for preparing the insert for use is also disclosed.

Assembly of the IGU With Insert

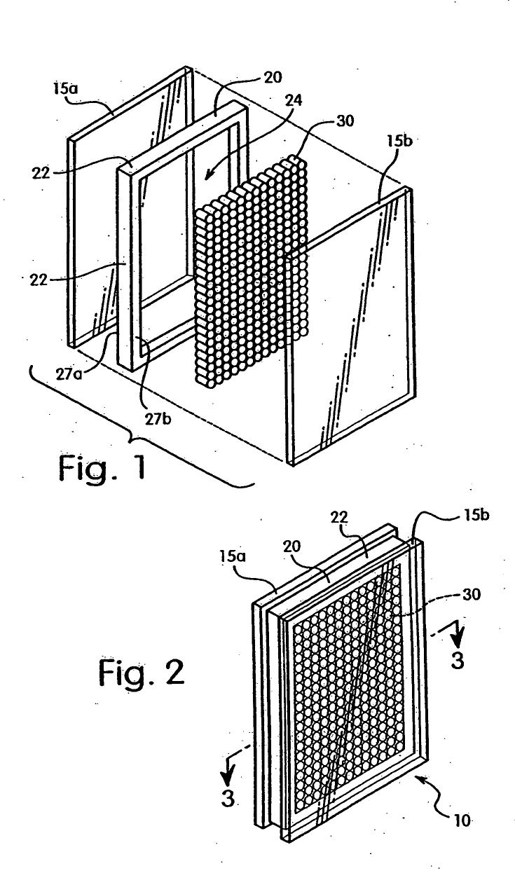

Turning now to the drawings, FIG. 1 illustrates an exploded view of the parts of an unassembled embodiment of an architectural IGU with a honeycomb insert. FIG. 2 illustrates a perspective view of an assembled IGU 10. Arrows indicate how the unassembled parts fit together to form the assembled IGU 10.

The assembled IGU 10 has two glass facings 15a and 15b, also commonly referred to as glass lites, and herein the two terms are used interchangeably. As the two glass facings 15a and 15b are intended to be secured together as one unit, they have roughly the same length and width. Standard glass facings of the size and type commonly used in the industry are acceptable for use in the present invention and are specifically contemplated for use. Non-limiting examples of the types of glass commonly used include laminated, low-iron, heat-strengthened, annealed, float, or tempered glass. Custom colored PVB interlayer is also compatible with the present invention, as are, without limitation, glass finishes such as sand-blasting, acid-etching, ceramic frit, low-e, reflective or tinted coatings. The IGUs of the present invention are applicable to both indoor and outdoor use, therefore, the specific size and material used for the facing depends on the intended application. Although glass is overwhelmingly used in the industry and is preferred for use in the present invention, other types of facings may be used, for example plastic.

The two glass facings 15a and 15b are positioned together by a perimeter spacer 20. The perimeter spacer 20 provides the framework for securing the two glass facings 15a and 15b as a unit and for creating the airspace 24 for the insertion of an insert 30. The perimeter spacer 20 is preferably constructed from aluminum, although other materials may be used. Again, standard perimeter spacers of the size and type commonly used in the industry are acceptable for use in the present invention and are specifically contemplated for use. The perimeter spacer 20 has an outer edge 22 and walls 27a and 27b on either side of the outer edge 22 extending substantially perpendicular. The perimeter spacer 20 is sized to according to the size of the glass facings 15a and 15b. In the preferred embodiment, the length and width of the outside edge of the perimeter spacer 20 are typically slightly smaller than that of the glass facings 15a and 15b so that when the unit 10 is assembled, the edges of the two glass facings 15a and 15b will extend slightly beyond the outer edge 22 of the perimeter spacer 20. In an alternate design, the spacer can be placed all the way to the edge of the glass lites. The edges of the glass facings 15l and 15b typically are sized to extend about ¼ inch beyond the outer edge 22 of the perimeter spacer 20 created a shallow gap between the two glass lites at the outer edge. When the two glass facings 15a and 15b are positioned in this manner, an airspace 24 is created in the middle of the IGU 10.

An insert 30 is positioned in the airspace 24 of the IGU 10 between the two glass facings 15a and 15b and within the perimeter spacer 20. The preferred insert is made from open cell honeycomb, and more specifically regular polycarbonate tubular honeycomb is most preferred. The term regular refers to the size of the individual tubes of the honeycomb material, and indicates that the individual tubes are identical or nearly identical in size. The use of regular tubular honeycomb creates a unique visual effect. Preferred cell diameters are ⅛″, 3/16 or ¼′,″ however other sizes may be used. Additionally, the insert may be composed of other materials and m ay have alternate cellular shapes. The preparation of the insert is discussed more fully below.

To assemble the IGU 10, a first glass panel 15a is adhered to the wall 27a of the perimeter spacer 20. Typically, adhesive is applied to the wall 27a of the perimeter spacer 20 secure the glass lite 15a to the perimeter spacer 20. The adhesive will create a seal between the glass lite 15a and the perimeter spacer 20. The adhesive, also referred to as the primary sealant is preferably polyisobutylene (PIB), however, other sealants or adhesives may be used. Once in position, a space is created for the insert 30 to be positioned.

The insert 30 is placed in position followed by the second glass lite 15b. Again, adhesive is applied to the walls 27a and 27b of the perimeter spacing 20 to secure the second glass lite in position and to create a hermetic seal. Optionally, desiccant can be injected into the perimeter spacer, which is hollow to ensure that little or no moisture remains inside the airspace 24 of the assembled IGU 10. The assembly is preferably completed with the application of a secondary sealant, applied to the outer edge 22 of the perimeter spacing 20. Typically, this would be applied in the shallow gap at the outer edge between the glass lites. The preferred secondary sealant is a two-part silicone seal, which is IGCC-certified and CBA rated so that the unit can be approved by the architecture glazing industry.

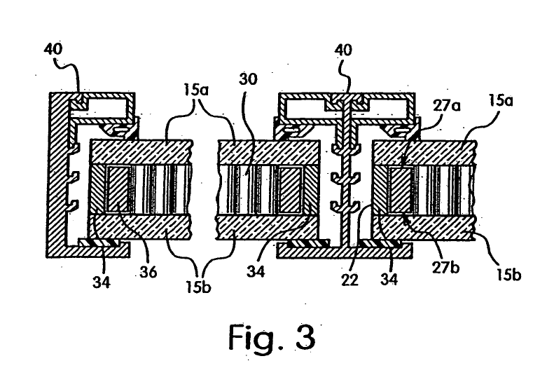

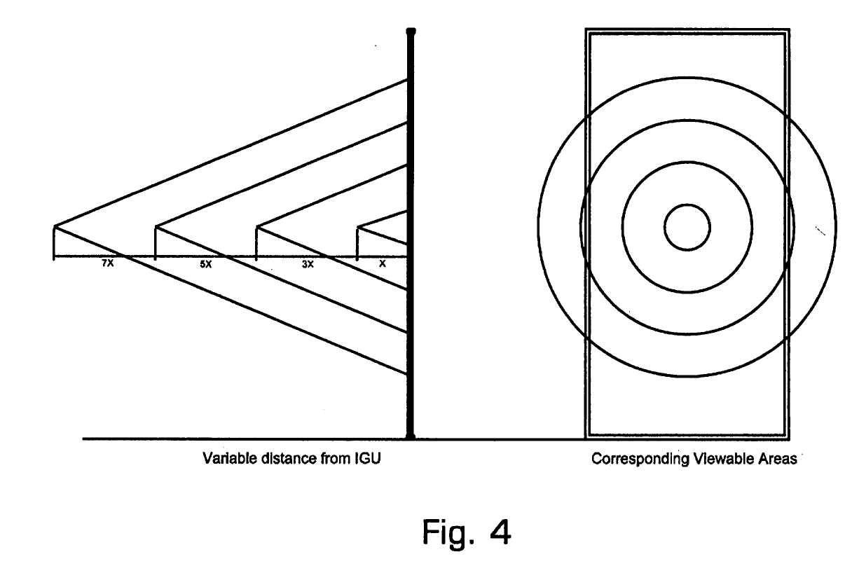

FIG. 3 illustrates a cut-away sectional view of a portion of an assembled IGU of the present invention. The position of the primary sealant 32 and secondary sealant 34 is shown. Also shown is the preferred positioning of the optional desiccant 36. As is common in the industry, the desiccant is injected into the hollow spacer before the spacer is properly positioned.

Also shown in FIG. 3 are framing devices 40 used for securing the IGUs in place. As can be seen, framing devices 40 are standard frames used in the industry for securing IGUs. No special clamps or devices are required for installation of the IGUs of the present invention. The IGUs with inserts of the present invention function structurally as other IGUs but have the added benefits and advantages of the inserts. They are completely compatible with existing and standard equipment and intended to be used with such.

Preparation of the Insert

The type of insert is an important consideration as the cell size, core thickness, and cell wall opacity will affect the visual characteristics and heat transmitting qualities. Tubular Polycarbonate open-cell honeycomb is the preferred material for use as an insert. Typically tubular polycarbonate is produced in b lock form, by thermally fusing multiple identical extruded tubes of polycarbonate. The block can then be sliced to the specific thickness as required to fit into the airspace of an insulating glass unit. This method for the preparation of the insert is the preferred method, however other methods may be used. Methods such as molding, stamping, extruding, or other additional methods not described here can be used to prepare the insert.

In the preferred embodiment, to maximize the quality of the final IGU, the core blocks are cut or sliced such that no shavings, burrs, or other trace of the slicing of the cores is visible once the block has been sliced into multiple singular ‘inserts’. To achieve this type of cut, the preferred method of cutting employs a high speed rotating saw blade capable of achieving the necessary quality.

The preferred method of preparation also employs a vacuum system at this point in the tubular honeycomb insert production. The dust generated by the sawing is removed as much as possible from the core insert by a downdraft vacuum system. The cut honeycomb is placed on an open grid framework and the dust is vacuumed from below, but the dust traces outlining the grid support may remain on the core. Existing markets for tubular core honeycomb do not usually require visual-grade dust removal at this stage of production as other industries do not require a higher degree of cleanliness of the this material. The phrase “visual grade” means that the open cell insert should be as visually consistent as possible as it may be used in an architectural setting. A visual grade core has a very regular cell configuration and negligible levels of dust deposits, shavings, or other impurities or traces of the cutting or cleaning process. In general, the preferred core is as visually consistent as possible with no outstanding irregularities or imperfections.

In order to meet the high aesthetic requirements of the architectural market, preferably the tubular open-cell insert is cleaned by using the cleaning process described below. Alternate processes designed to achieve the desired cleanliness may also be used.

It is a standard practice in the architectural glazing industry to fabricate or install the structural framing members before specifying the exact size of and ordering the final IGUs so that the relationship between the unit and framing is precise and any unnecessary stresses on the system are avoided. Therefore, once the final IGU dimension has been determined, the sliced insert can be cut to the specified dimension, at which point it may be processed further so that the final assembled IGU with an open cell insert is as visually consistent as possible.

In order to achieve the best fit into the airspace of an IGU, inserts are preferably cut using a computer numerically controlled (CNC) saw. This provides the necessary ‘visual grade’ tolerance of the cut and ensures that the insert aligns properly with the perimeter spacer at the perimeter of the unit. It is important to cut the cores to the desired size before the final cleaning stage as described below. In keeping with the tolerances of both the insulating glass unit industry and tubular honeycomb core production, the honeycomb core insert is preferably sliced to a maximum of about 0.04″ less in thickness and +0.03″ to −0.00″ in length and width than the specified airspace of the intended IGU into which it will be inserted. Performance problems may arise as the result of improperly sized inserts. If the insert is too thick, it can prevent an accurate bond of the second glass lite to the perimeter spacer, which may compromise the weather seal and the overall integrity of the unit. If the insert is too thin, it can rattle in the airspace against the glass facings creating an unpleasant noise, which is undesirable in the architectural industry. In addition, the relationship between the insert thickness and the airspace is carefully determined to take into account the thermal expansion of the core by evaluating the coefficients of expansion and contraction of the core insert in relation to that of a typical insulating glass unit.

Because polycarbonate tubular honeycomb is not commonly used in an application requiring it to be visual grade, as the architectural IGU market requires, the dust removal process currently employed by most vendors does not sufficiently remove the dust from the insert. In the preferred embodiment, the cleaning system described below is utilized to clean the core to visual grade specifications. However, depending on the specific application of the IGU, this level of cleaning may not be required and other cleaning methods may be used.

The application of high pressure air using regularly spaced air nozzles sufficiently cleans the inserts to visual grade quality. The cores are placed on an open support structure with narrow supports (about ⅛″ wide or less) which allows the air from the nozzles to flow through the insert, thereby cleaning the cell wall through the entire depth of the insert.

The nozzles are connected to a hollow air flow tube in such a pattern as to allow maximum and even air distribution. The tube is connected to a large volume air compressor unit [recommended 120 psi/ with at least 300 scfm capacity]. Because the nozzles are fan shaped and the air tends to spread out once it leaves the nozzle, best results are achieved when the nozzles are staggered such that the air flow from one nozzle overlaps slightly the air flow from the contiguous nozzles. This ensures that there are only minimal gaps in air pressure over the surface of the insert and will result in the most consistent cleaning.

The cleaning steps above are preferably employed in a clean room environment with a negative air pressure and with a downdraft or cross-draft air circulation system such that air enters the enclosed booth from the top or side and is removed from the floor or opposite wall, as this enhances the effectiveness. This will ensure that the dust removed from the inserts does not float freely in the environment and possibly redeposit on the insert.

Air in the booth is preferably free of oil and moisture. The insert is preferably cleaned well on each side with a minimum of three passes, overlapping by at least 50% each pass. The first pass over the entire core insert is parallel to one side of the insert, the second pass is perpendicular to the first pass, and the third pass is at a 45 degree angle to the 2^{nd} pass. If a fourth pass over the core is necessary, it should be performed perpendicular to the 3^{rd} pass. The edges of the inserts are cleaned as well and all partially cut cell wall material should be removed. Cleaning is preferably performed in a well lit area to confirm that the entire insert is thoroughly cleaned and no streaks remain. Finally, cleaned inserts should be removed from the cleaning room to ensure that no dust will redeposit.

Once the cores are cut and cleaned as described above they are preferably stored with the use of anti-static films to avoid latent dust in the environment from being deposited back onto the cell walls.

Use and Benefits of IGU With Insert

The physical shape, plastic nature and light transmitting properties of the insert, and specifically the preferred tubular polycarbonate honeycomb, provide multiple benefits when inserted in the airspace of an IGU that is typically used in the architectural industry. Although the IGUs with inserts of the present invention are particularly suitable as a weather and insulation barrier between indoor and outdoor spaces, because of the thermal and sound insulating properties as well as visual and other properties afforded by the insert, the present invention can also be used to separate interior spaces.

One of the main benefits of the present invention is the ability to better manipulate and control the visual characteristics of the IGU. When the tubular honeycomb core is inserted into the airspace of an insulating glass unit, thereby putting this honeycomb into the sightlines of observers, the cell walls of the tubular honeycomb, which is sliced to fit into the airspace of the unit, restrict the sightlines of an observer depending upon the observer's position in relation to the panel.

The honeycomb depth is related to the depth of the airspace of the IGU, which typically has standard industry dimensions ranging from 5/16″ to ¾″ in depth. Other depths may be used, however depending on the application. The honeycomb cell walls restrict the lines of sight, or cone of vision, as the sight lines encounter the first cut surface and then the second cut surface of the honeycomb core.

Assuming a 90 degree [perpendicular] view, there is more visual transparency in the center of the observer's cone of vision and less as the sightlines are interrupted by the honeycomb cell walls. As the observer's distance from the panel increases, assuming an axis perpendicular to the face of the panel, the observer's cone of vision enlarges in relation to the face of the panel resulting in more visual transparency because fewer sightlines are being interrupted by the cell walls of the honeycomb (see FIG. 4).

A direct result of this visual property is the ability to control the amount of privacy offered by the panel: the tubular nature of the honeycomb restricts the sight lines of an observer depending upon the proximity of that observer to the unit.

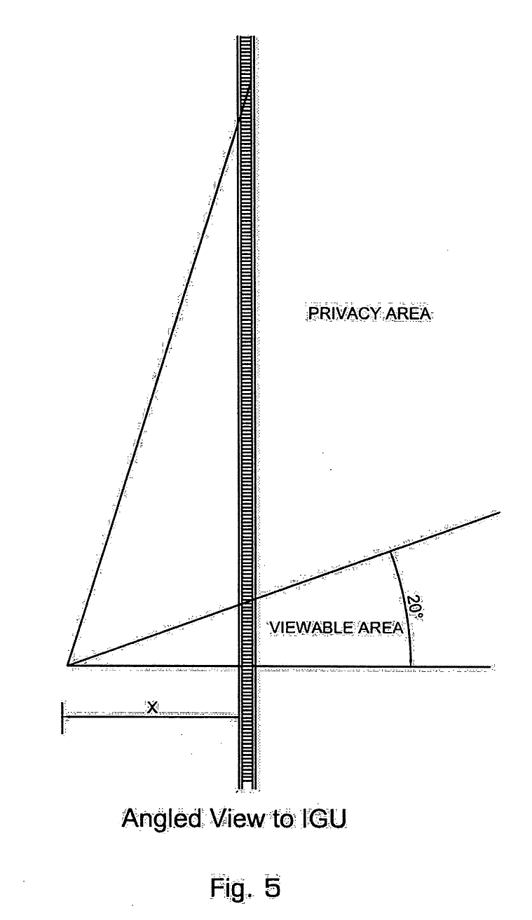

The degree of privacy also varies as the observer's angle of view towards the panel changes. The greatest degree of privacy is offered when the observer is at an oblique angle to the unit (see FIG. 5). The 90° degree view angle offers the clearest vision and least amount of privacy. Because of the possibility to vary the light transmitting properties of the polycarbonate honeycomb—from transparent to opaque cells walls—more or less privacy can be offered depending upon the specification of the cell wall. The more transparent the polycarbonate, the less privacy can be expected.

The amount of privacy can also be controlled by the depth of the insert and associated airspace, and by the density of the insert. Assuming a constant distance from the observer to the IGU, the angle at which all sightlines are interrupted and there is no visibility through the panel is directly related to the thickness and cell size of the core insert.

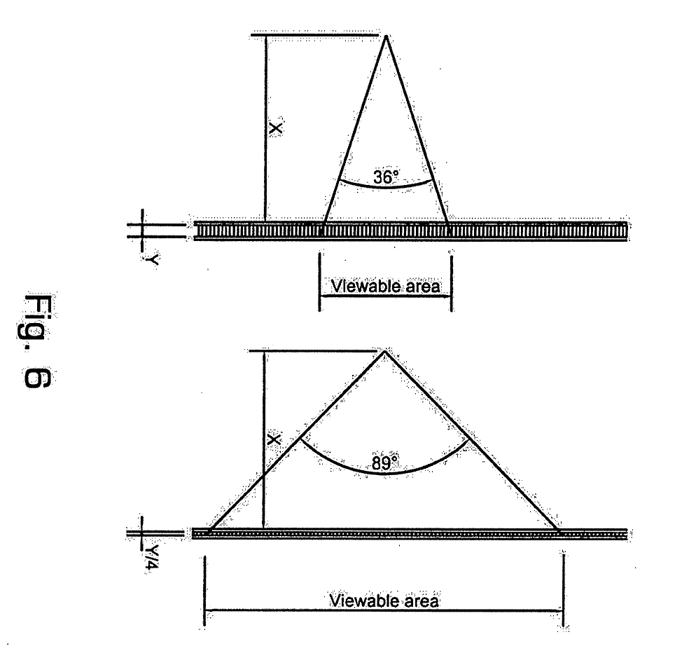

Thinner inserts result in increased transparency and therefore decreased privacy because the sightlines encounter the second cut surface of the cell wall sooner, allowing the sight line to continue into the space beyond with less interruption by the cell wall itself (see FIG. 6).

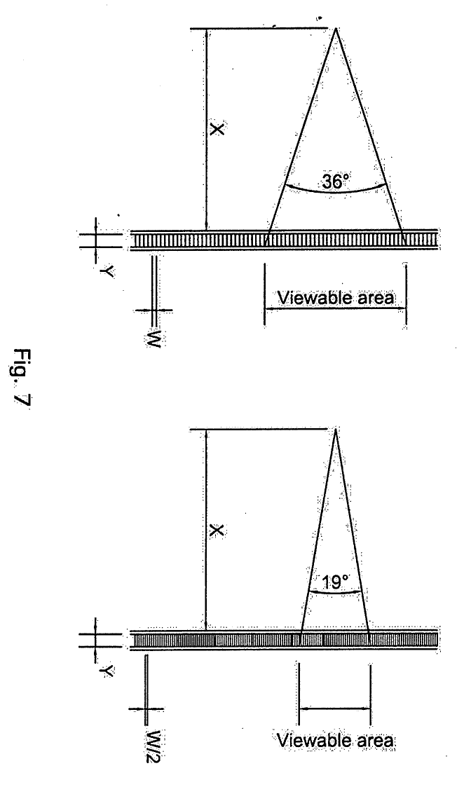

Varying the cell size of the tube core honeycomb will also affect the amount of privacy—smaller cells will restrict the sight lines more dramatically than larger cells because of the smaller diameter and thereby offer a greater degree of privacy (see FIG. 7).

In a similar vein, the amount of light being transmitted through the panel can better be controlled by varying the properties of the insert. This is especially important with windows that are exposed to direct sunlight for large portions of the day. This control over privacy and light makes the IGU of the present invention equally suitable for interior applications. Additionally, different colors degrees of translucency/opacity of materials used for the insert may be used to further enhance these properties, as well as to offer greater design flexibility to the architect or specifier.

Another main benefit of the addition of the insert to the IGU is the increase in energy efficiency. The IGU with insert of the present invention limits the amount of direct sunlight that can penetrate the unit, thereby decreasing the amount of heat transmitted into the interior space of a building. The reduced heat in the interior space lessens the need for energy-dependent cooling systems, reducing the overall expenditure of energy in the building. In comparison to a typical IGU with no insert, the IGU with insert of the present invention achieves reduced Shading Coefficient and Solar Heat gain Coefficient values comparable to an IGU with a low-C coating. These low values are desirable in the fields of architecture and building. The IGU with insert of the present invention can also be produced with low-e coatings. The combined effect of the insert and the low-e coating achieves further reduced Shading Coefficient and Solar Heat gain Coefficient values.

Also, the insert occupying the airspace reduces convection of the air within the unit and correspondingly, the amount of heat transmitted into the interior spaces.

Variations of the Inserts

The type, shape and regularity of the basic insert may be varied. This is another way to achieve different visual effects. One variation is to have more than one individual insert in a single IGU. For example, 2 or more inserts may be sliced to fit together in the airspace and create an overlapping pattern.

Another variation is to vary the thickness of a single insert within an IGU. In the basic unit described above, the insert is sliced to be consistent thickness. However, the insert thickness may be manipulated for aesthetic or visual privacy purposes. For example the insert may be cut on an angle such that it is of standard thickness at the base of the unit and then tapers to gradually become thinner towards the top. A unit with this type of insert would be obscure at the base and allow clearer vision at eye-level. For another example, the insert could be of one thickness for the majority of the unit but have a decorative pattern milled into its thickness in various areas in the insert to create a three dimensional visual effect. Units prepared with thickness variations must be prepared without compromising the stability of the insert within the unit. Therefore a portion of the insert has to remain thick enough to keep the insert stable in the airspace within the unit.

One other variation is to have a variety o f different c ell sizes within a single insert. As mentioned above, the preferred embodiment utilizes regular open cell honeycomb as the insert material. However, multiple sized cells within a single insert may be used for a different visual effect. The insert would maintain similar functions in terms of the aesthetics, visibility, and thermal performance but offers another option to manipulate the visual characteristics both for esthetic and privacy.

1. An architectural insulating glass unit comprising:
two glass facings;
an open cell honeycomb insert sized to be positioned between the two glass facings in the insulating glass unit; and,
a perimeter spacer dimensioned to secure the two glass facings and the open cell honeycomb in the insulating glass unit, wherein the open cell honeycomb insert is between the two glass facings.

2. The architectural insulating glass unit of claim 1 wherein the open cell honeycomb insert is constructed from polycarbonate tubular honeycomb.

3. The architectural insulating glass unit of claim 1 wherein the open cell honeycomb insert is regular.

4. The architectural insulating glass unit of claim 1 wherein the open cell honeycomb insert is constructed from polycarbonate tubular honeycomb that is regular in cell configuration.

5. The architectural insulating glass unit of claim 1 wherein the open cell honeycomb insert is cut in a range of about 0.00″ to 0.04″ less in thickness than the specified airspace of the IGU into which it is inserted.

6. The architectural insulating glass unit of claim 1 wherein the open cell honeycomb insert is prepared using a dust removal process producing a visual grade insert.

7. A method for preparing an insert for insertion into the airspace of an insulating glass unit comprising the following steps:
slicing a block of open cell tubular honeycomb into sheets of a thickness compatible with the thickness of the airspace of the insulating glass unit;
cutting the sheets of open cell tubular honeycomb to a length and width compatible with length and with of the airspace of the insulating glass unit to form an insert; and
cleaning the insert using high pressure air.

8. The method of claim 7 wherein slicing a block of open cell tubular honeycomb is performed with a high speed rotating saw blade.

9. The method of claim 8 wherein dust generated by the high speed rotating saw blade is removed as much as possible from the core insert by a downdraft vacuum system.

10. The method of claim 9 wherein cutting the sheets of open cell tubular honeycomb to a length and width is performed using a computer numerically controlled saw.

11. The method of claim 10 wherein the sheets are cut in a range of about +0.03″ to −0.00″ in length and width less than the specified airspace of the IGU into which it will be inserted.

12. A method for constructing an architectural glass unit comprising the following steps:
adhering a first lite of glass to a spacer, thereby forming an airspace within the spacer adjacent to the first lite of glass;
placing an open cell honeycomb insert into the airspace adjacent to the first lite of glass; and, ‘adhering a second lite of glass to the spacer, wherein the open cell honeycomb insert is sized to fit securely within the perimeter of the spacer between the first and second lite of glass.

13. The method of claim 12 further comprising the step of sealing the unit with a secondary seal.

14. The method of claim 13 wherein the secondary seal of the unit consists of a 2-part silicone seal.

15. The method of claim 12 wherein the open cell honeycomb insert is regular cell honeycomb.

16. An architectural insulating unit comprising,
two visually transparent sheets;
a space separating the two sheets; and
an insert between the two sheets that restricts the sightlines of observers through the unit to cones of vision, thereby providing areas of privacy outside the cones of vision of observers.

17. The unit of claim 16 in which the cones of vision through the unit increase in size as the distance of the observer from the unit increases.

18. The unit of claim 16 in which the sheets are free of any films of glue and the sightlines of observers through the unit pass only through the two sheets.

19. The unit of claim 16 in which the unit includes small bounded areas extending between the sheets, and the cones of vision (a) increase in size as the distance across the bounded areas increases and (b) decrease in size as the distance between the visually transparent sheets increases.

20. The unit of claim 19 in which the multiple, small bounded areas are created by a polycarbonate regular tubular honeycomb cellular structure extending from one sheet to the other sheet.

21. The unit of claim 20 in which the unit has a perimeter spacer and the honeycomb is about 0.00 to −0.04 inches in the thickness and 0.00 to 0.03 inches in length and width relative to the specified air space defined by the sheets and the spacer.

22. An architectural insulating unit consisting essentially of,
two visually transparent sheets;
a perimeter spacer positioned at the perimeter of the visually transparent sheets with sealants holding the two sheets in place; and
an insert between the two sheets that restricts light rays that can penetrate directly through the unit to only light rays that strike the unit within a predetermined cone.

23. The unit of claim 22 in which the material of the insert is translucent and the unit allows for diffuse transmission of light.

24. A method of making an insulating glass unit having a specified air space defined by two sheets of glass and a perimeter spacer comprising,
slicing a block of open cell tubular honeycomb into slabs having a thickness comparable to the thickness of the specified air space;
cutting the honeycomb into a slab having a length and a width comparable to the length and width of the specified air space; and
cleaning the honeycomb to remove visible levels of dust and other contaminants.

25. The method of claim 24 which employs high pressure air.

26. The method of claim 24 which includes a clean room environment with an air circulation system that ensures that substantially all dust does not float freely in the environment.

27. The method of claim 24 further comprising, enclosing the slab in the two sheets and the perimeter spacer and adhering the sheets to the perimeter spacer.

28. The process of claim 27 further comprising,
adhering one glass sheet to the perimeter spacer;
placing the slab within the perimeter spacer adjacent to the glass sheet; and
adhering a second sheet to the perimeter spacer to enclose the slab in the space between the two sheets of glass.

29. An architectural insulating unit having a predetermined air space between two visually transparent sheets, the unit consisting essentially of,
two visually transparent sheets;
a perimeter spacer with sealants holding the two sheets in place, the sheets and the spacer defining a space; and
in the space, a slab structure having rows of bounded, open areas extending from one face of the slab to the other.

30. The unit of claim 29 in which the slab structure is an open cell polycarbonate regular tubular honeycomb.
